(19) United States
(12) Patent Application Publication
(10) Pub. No.: US 2016/0261541 A1
(43) Pub. Date: Sep. 8, 2016

(54) PRIORITIZING LOG MESSAGES

(71) Applicant: HEWLETT-PACKARD DEVELOPMENT COMPANY, L.P., Houston, TX (US)

(72) Inventors: Eran Samuni, Yehud (IL); Fernando Vizer, Yehud (IL); Liya Brodin, Yehud (IL)

(21) Appl. No.: 14/896,643

(22) PCT Filed: Jun. 7, 2013
(86) PCT No.: PCT/US2013/044691

§ 371 Date: Dec. 7, 2015

(51) Int. Cl. H04L 12/58; G06F 17/30; H04L 29/08

(52) U.S. Cl. CPC H04L 51/26; H04L 67/10; G06F 17/3053

(57) ABSTRACT

Prioritizing log messages can include generating a cluster of a plurality of log messages relating to an event and receiving feedback from a number of users relating to an event relevance of the cluster. Prioritizing can also include isolating a number of log messages based on the feedback and predicting a number of future events utilizing the isolated number of log messages.

### BACKGROUND

Event logging can include monitoring computing events (e.g., start up, shut down, error events, security events, etc.) and recording log messages (e.g., event logs, error logs, security logs, etc.). The log messages can be stored in a database and utilized to track computing processes for a computing system. The log messages can correspond to events that can affect the computing system. For example, the log messages can correspond to a computing error and can include information relating to the computing error.

### BRIEF DESCRIPTION OF THE DRAWINGS

FIG. 1 illustrates a diagram of an example of an environment to prioritize log messages according to the present disclosure.

FIG. 2 illustrates a diagram of an example of a user interface according to the present disclosure.

FIG. 3A illustrates a diagram of an example of a system to prioritize log messages according to the present disclosure.

FIG. 3B illustrates a diagram of an example computing device according to the present disclosure.

FIG. 4 illustrates a flow diagram of an example method for prioritizing fog messages according to the present disclosure.

### DETAILED DESCRIPTION

Computing systems can utilize event logging to monitor and store information (e.g., log messages, event logs, error logs, etc.) relating to events that are performed by a computing system (e.g., environment 100, etc.). The event logging can produce a relatively large quantity of log messages (e.g., data logs, event logs, security logs, error logs, etc.) that can include data relating to events that are performed by the computing system. Prioritizing log messages can include determining a number of log messages that have a higher probability of being a cause and/or root cause of a particular event and utilizing the log messages to predict future events.

Prioritizing log messages can include generating a number of clusters that include log messages with a similar pattern. The clusters can be utilized to identify a number of log messages with similar characteristics (e.g., template features, variable features, etc.). User feedback can be provided by a number of users. The user feedback can be a user's opinion of whether or not the number of log messages are a cause and/or a root cause of a particular event. The user feedback can be utilized to calculate a score for each of the log messages and/or for each of the number of clusters. The log messages can be prioritized based on the score. Log messages with a relatively high score in relation to a particular event can be utilized to predict when the particular event will occur at a future time within the computing system. That is, the prioritized log messages can be compared to newly incoming log messages to determine if a particular event corresponding to the prioritized log messages will occur within the computing system.

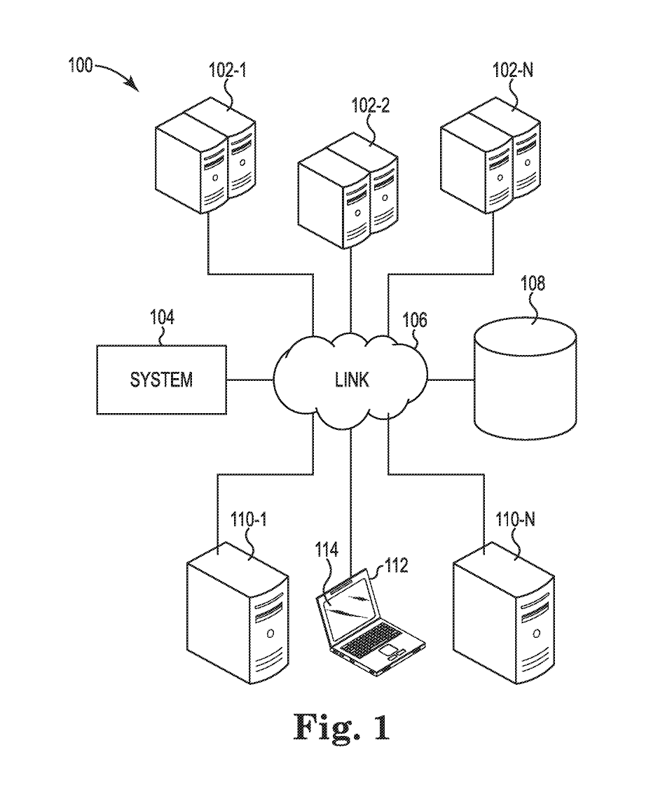

FIG. 1 illustrates a diagram of an example of an environment 100 to prioritize log messages according to the present disclosure. The environment 100 can include a prioritizing log system 104, a data store 108, server devices 102-1, 102-2, . . . , 102-N, and/or client devices 110-1, . . . , 110-N. The client devices 110-1, . . . , 110-N can include a client device 114 that includes a user interface 112.

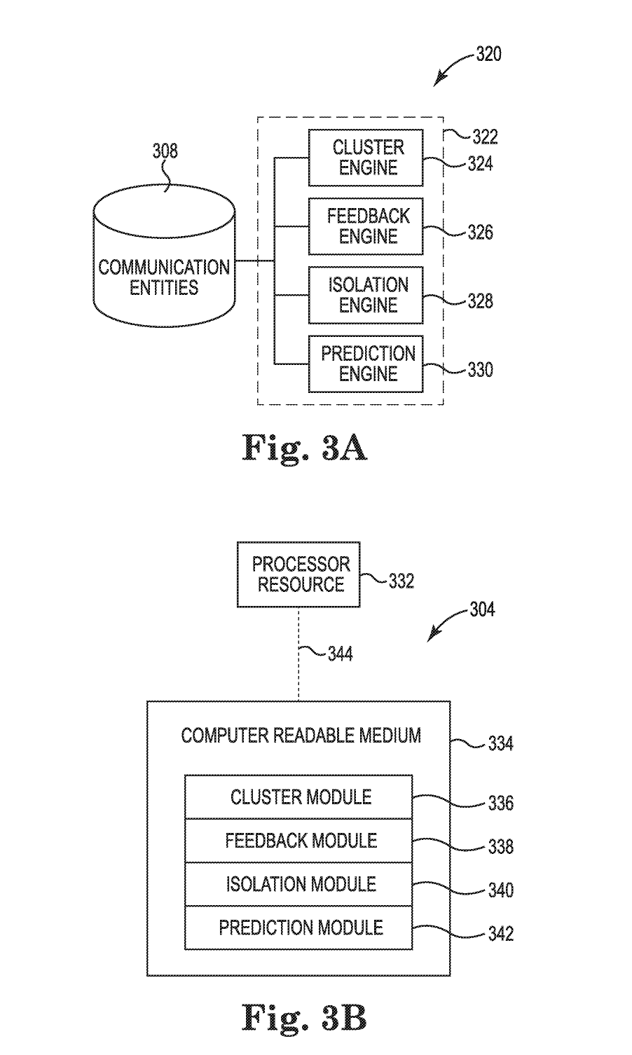

The prioritizing log system 104, as described herein, can represent a number of different combinations of hardware and software configured to prioritize and isolate a number of log messages to predict a number of future events. The prioritizing log system 104 can include the computing device 304 represented in FIG. 3B.

The server devices 102-1, 102-2, . . . 102-N can be a computing device that can be configured to respond to network requests received from the client devices 110-1, 110-N, 112. The client devices 110-1, 110-N, 112 can include browsers and/or other applications to communicate requests with the prioritizing system 104, data store 108, and/or server devices 102-1, 102-2, . . . , 102-N via a communication link 106.

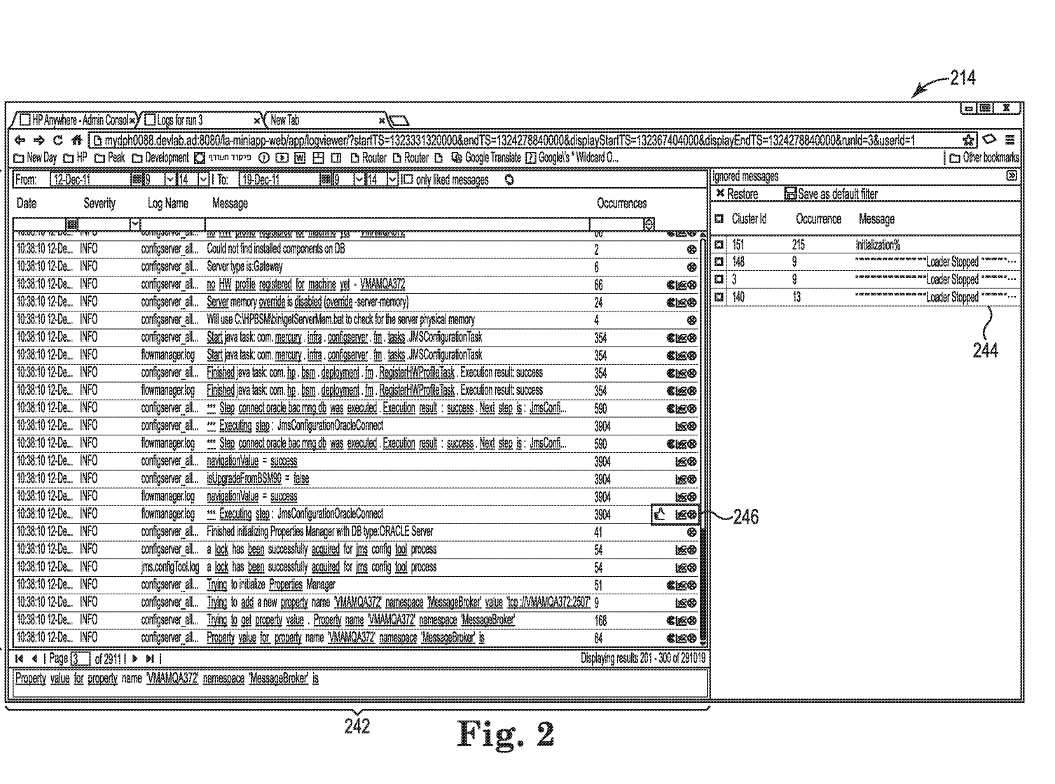

FIG. 2 illustrates a diagram of an example of a user interface 214 according to the present disclosure. The user interface 214 can be displayed on a display (e.g., display 114 referenced in FIG. 1, etc.) of a client device (e.g., client device 112 as referenced in FIG. 1, etc.). The user interface 214 can display a number of features of the prioritization log system (e.g., prioritization log system 104 as referenced in FIG. 1, etc.).

The user interface 214 can display a plurality of log messages within a log message window 240. The plurality of log messages can be sorted by a number of features including: log message template features, log message variable features, clusters, log name, occurrences of the log message, recommendation selection, among other features.

The user interface 214 can enable a user to interact with the plurality of log messages. The user can utilize the user interface 214 to display particular data relating to the plurality of log messages. For example, a user can utilize the user interface 214 to view log messages within a particular time period and/or within a particular cluster of log messages. The cluster of log messages can be generated utilizing features described herein.

In another example, the user can utilize the user interface 214 to view log messages within a particular cluster. For example, the user can select a cluster within a cluster window 244. The cluster window 244 can include a number of clusters that each includes: a cluster ID, a number of log message occurrences within each cluster, and a message relating to the cluster, among other features. The cluster window 244 can enable a user to select, de-select, delete, and/or sort a number of clusters that have been generated. The cluster window 244 can display the number of log message occurrences of a particular cluster in the log message window 240 when a cluster is selected. For example, within the cluster window 244, a user can select cluster ID 151 and the 215 log message occurrences within oldster ID 151 can be displayed within the log message window 240.

For each cluster, a particular log message template can be defined by determining a number of consistent features. The log message template can be a number of features within the plurality of log messages that are consistent for each log message. For example, the log message template can include consistent terms such as “value”, “property”, and/or “namespace”, among other terms. The consistent terms can be terms that must appear in order for the log message to be included within a particular cluster. In another example, the log message can be included within a particular cluster if the log message has a threshold number (e.g., predetermined threshold number) of the consistent terms.

A log message template can be displayed within the log message template window 242. The log message template can include a number of consistent terms as described herein. The log message template terms can be identified within the log message window 240. For example, the log message template terms can be underlined within the log message window 240. Identifying the log message template terms can be compared throughout the log message window 240.

The user can utilize the user interface 214 to provide feedback for the plurality of log messages. For example, the user can provide feedback by selecting “like” and/or “dislike” via a selection menu 246. The selection menu 246 can correspond to the plurality of log messages within the log message window 240.

The feedback can be provided based on whether or not the user believes the corresponding log message is a cause and/or root cause of a particular computing event (e.g., computing error, computing failure, security threat, etc.). That is, the user believes the log message has a relatively high event relevance (e.g., log message is relevant to the event) compared to other log messages. For example, a user can experience a computing error and upon determining that the computing error was likely caused by a particular log message can provide a “like” selection via the selection menu 246. The “like” selection can be provided by selecting a “thumbs up symbol” within the selection menu 246. In this example, the feedback can be utilized to score each of the clusters and determine a cluster with a higher score compared to the other clusters. The cluster with the higher score can be utilized to predict future computing events, such as computing errors. That is, the log message template and a number of log message variables corresponding to log messages within the cluster with the higher score can be compared to incoming log messages.

Each of the plurality of log messages within a cluster can be scored. Each of the log messages can be scored utilizing the user feedback provided using the selection menu 246. By scoring each of the log messages within the cluster, a particular log message with a higher score can be isolated from the rest of the cluster, and the template features and variable features of the isolated log message can be used to compare to incoming log messages.

FIG. 3A illustrates a diagram of an example of a system 320 to prioritize log messages according to the present disclosure. The system 320 can include a data store 308 (e.g., data store 108 as referenced in FIG. 1, etc.), a prioritizing system 322, and/or a number of engines 324, 326, 328, 330. The prioritizing system 322 can be in communication with the data store 308 via a communication link, and can include the number of engines (e.g., cluster engine 324, feedback engine 326, isolation engine 328, prediction engine 330, etc.). The prioritizing system 322 can include additional or fewer engines than illustrated to perform the various functions described herein.

The number of engines can include a combination of hardware and programming that is configured to perform a number of functions described herein (e.g., generating a cluster of a plurality of log messages relating to an event, receiving feedback from a number of users relating to an event relevance of the cluster, etc.). The programming can include program instructions (e.g., software, firmware, etc.) stored in a memory resource (e computer readable medium, machine readable medium, etc.) as well as hard-wired program (e.g., logic).

The cluster engine 324 can include hardware and/or a combination of hardware and programming to generate a cluster of a plurality of received (e.g., accessed) log messages relating to an event. The plurality of log messages can be received and stored in a database (e.g., data store 108, etc.) and accessed by the cluster engine 324.

Generating a cluster can include separating the plurality of log messages into groups that share a particular pattern. For example, generating the cluster can include comparing a number of template features and a number of variable features to determine if a particular log message has a similar pattern to a current cluster. If the particular log message has a similar pattern to the current cluster, the particular log message can be placed in the current cluster. If however, the particular log message does not have a similar pattern to the current cluster, then the particular log message can be placed into a different cluster or a new cluster can be generated to include the particular log message.

Determining if a first log message has a similar pattern to a second log message can include comparing the number of template features of the first log message to the number of template features of the second log message to see if the template features are the same for both the first log message and the second log message. The template features can include terms that represent criteria (e.g., log type, value, property, code name, etc.) of the log messages. It can be determined that the first log message and the second log message share the same and/or a threshold (e.g., predetermined threshold) of criteria when the first log message has the same template features as the second log message.

If it is determined that the first log message and the second log message share the same criteria, then the number of variable features of the first log message and the variable features of the second log message can be compared. It can be determined that the first log message and the second log message belong in the same cluster if the variable features of the first log message and the variable features of the second log message have similar values. It can be determined that the variable features have similar values if the actual quantity of the variable feature is relatively similar. That is, if the variable feature is a numerical value relating to a template feature, then the numerical values can be compared to determine if they are within a threshold (e.g., predetermined threshold). If the numerical values are within a predetermined threshold the log messages can be included within the same cluster. If the numerical values are outside the threshold, the log messages can be separated into different clusters.

The variable feature can also be a term or code of letters and the comparison between these variable features can be similar to comparing numerical values. For example, a code of letters from a first log message can be compared to a code of letters from a second log message. If the number of differences between the code of letters from the first log message and the code of letters from the second log message is within a threshold (e.g., 3 differences, 2 differences, etc.), then the first log message and the second log message can be included within the same cluster. However, if the number of differences are outside the threshold, then the first log message and the second log message can be separated into different clusters.

The feedback engine 326 can include hardware and/or a combination of hardware and programming to receive feedback, from a number of users, relating to an event relevance of the cluster. The feedback can be provided by the number of users utilizing a user interface (e.g., user interface 214 as referenced in FIG. 2, user interface 114 as referenced in FIG. 1, etc.). The number of users can select a “like” and/or “dislike” via the user interface and the selections can be received by the feedback engine 326.

The feedback engine 326 can assign a score to a log message that corresponds to the received feedback. For example, a user can select “like” via the user interface for a particular log message. In this example, the selection of “like” can indicate that the user believes that the log message is related (e.g., has an event relevance) to a particular event. Furthermore, the feedback engine 326 can give a positive score to the corresponding log message to indicate that the log message is more likely to be a cause (e.g., root cause, etc.) of the particular event. In contrast, if the user selected “dislike”, then the feedback engine 326 can give a negative score to the corresponding log message to indicate that the log message is less likely to be a cause of the particular event.

The feedback engine 326 can determine a qualification of the number of users and can utilize the qualification to determine a quantity of a positive score and/or a negative score. The qualification of the number of users can be a level of expertise in a particular area (e.g., area relating to a particular event, computing expertise, computing error expertise, programmer, system administrator, etc.). The quantity of a positive and/or negative score can correspond to the level of expertise. For example, if a user has a relatively high level of expertise it can be determined that a relatively high quantity of a positive and/or negative score can result when the user provides feedback. For instance, if it is determined that a user has a high level of expertise, it can be assumed that the feedback provided by the user has a higher probability of being correct.

The isolation engine 328 can include hardware and/or a combination of hardware and programming to isolate a number of log messages based on the feedback. The isolation engine 328 can isolate the number of log messages based on a total score that includes the quantity determined by the feedback engine 326. The total score can include a number of calculated quantity values for a number of features relating to the plurality of log messages and the feedback score. The number of features can include, for example: a time the log message was received, a time of an event, a previous score, among other features.

Based on the total score, the isolation engine 328 can store a number of log messages that exceed a threshold (e.g., predetermined threshold). For example, it can be determined that log messages with a relatively high score and/or a score that exceeds a predetermined threshold can be stored and utilized to predict future events. In this example, a log message that is isolated can correspond to a particular event, and the isolated log message can be used to predict a future event that is the same and/or similar as the particular event.

The prediction engine 330 can include hardware and/or a combination of hardware and programming to predict a number of future events utilizing the isolated number of log messages. Predicting the number of future events can include comparing the template features and the variable features of the isolated number of log messages to currently received log messages. The currently received log messages can be log messages that are generated after isolating the number of log messages. That is, the currently received log messages can be log messages that are being received during operation of the computing system.

Comparing the template features and the variable features can be performed similarly to clustering the number of log messages. That is, the template features of the isolated number of log messages can be compared to the features of the currently received log messages to determine if the template features are the same. If the template features of the currently received log messages are the same as the isolated number of log messages, then the variable features of the isolated number of log messages can be compared to the variable features of the currently received log messages.

If the variable features of the isolated number of log messages are similar or the same as the variable features of the currently received log messages then it can be determined that an event associated with the isolated number of log messages is likely going to occur on a computing device that experienced the currently received log message. As described herein in regards to clustering, comparing the variable features can include using a comparison to a threshold (e.g., predetermined threshold) to determine if the similarities are close enough to make the determination that the corresponding event is likely to occur (e.g. how likely to occur).

FIG. 3B illustrates a diagram of an example computing device 304 according to the present disclosure. The computing device 304 can utilize software, hardware, firmware, and/or logic to perform a number of functions described herein.

The computing device 304 can be any combination of hardware and program instructions configured to share information. The hardware, for example can include a processing resource 332 and/or a memory resource 334 (e.g., computer-readable medium (CRM), machine readable medium (MRM), database, etc.) A processing resource 332, as used herein, can include any number of processors capable of executing instructions stored by a memory resource 334. Processing resource 332 may be integrated in a single device OF distributed across multiple devices. The program instructions (e.g., computer-readable instructions (CRI)) can include instructions stored on the memory resource 334 and executable by the processing resource 332 to implement a desired function (e.g., generate a cluster of a plurality of log messages relating to an event, etc.).

The memory resource 334 can be in communication with a processing resource 332. A memory resource 334, as used herein, can include any number of memory components capable of storing instructions that can be executed by processing resource 332. Such memory resource 334 can be a non-transitory CRM or MRM. Memory resource 334 may be integrated in a single device or distributed across multiple devices. Further, memory resource 334 may be fully or partially integrated in the same device as processing resource 332 or it may be separate but accessible to that device and processing resource 332. Thus, it is noted that the computing device 304 may be implemented on a participant device, on a server device, on a collection of server devices, and/or on a combination of the user device and the server device.

The memory resource 334 can be in communication with the processing resource 332 via a communication link (e.g., path) 344. The communication link 344 can be local or remote to a machine (e.g., a computing device) associated with the processing resource 332. Examples of a local communication link 344 can include an electronic bus internal to a machine (e.g., a computing device) where the memory resource 334 is one of volatile, non-volatile, fixed, and/or removable storage medium in communication with the processing resource 332 via the electronic bus.

A number of modules 336, 338, 340, 342 can include CRI that when executed by the processing resource 332 can perform a number of functions. The number of modules 336, 338, 340, 342 can be sub-modules of other modules. For example, the isolation module 340 and the prediction module 342 can be sub-modules and/or contained within the same computing device. In another example, the number of modules 336, 338, 340, 342 can comprise individual modules at separate and distinct locations (e.g., CRM, etc.).

Each of the number of modules 336, 338, 340, 342 can include instructions that when executed by the processing resource 332 can function as a corresponding engine as described herein. For example, the cluster module 336 can include instructions that when executed by the processing resource 332 can function as the cluster engine 324. In another example, the feedback module 340 can include instructions that when executed by the processing resource 332 can function as the feedback engine 326.

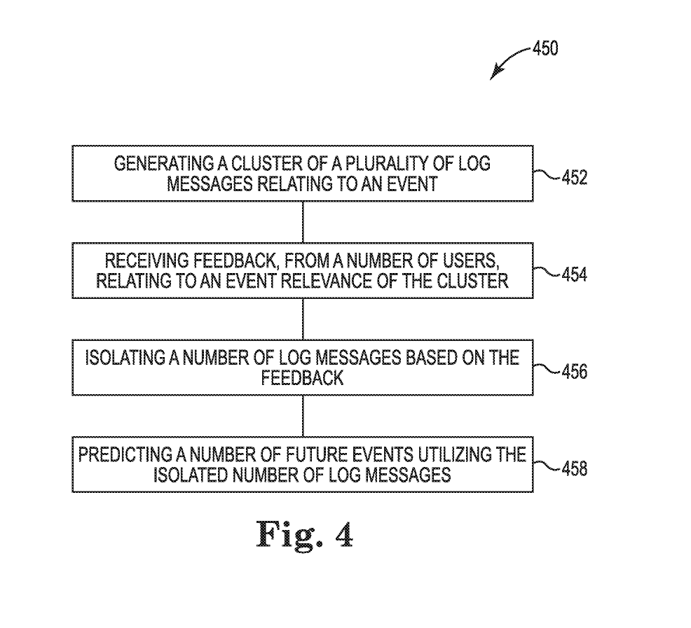

FIG. 4 illustrates a flow diagram of an example method 450 for prioritizing log messages according to the present disclosure. Prioritizing log messages can include determining a number of log messages that include a higher probability for being a cause and/or root cause of a particular event when compared to other log messages within the same and/or different cluster. That is, there may be a plurality of log messages that relate to a particular event (e.g., event relevance), but particular log messages with a higher priority can be more closely related to the cause and/or root cause of the event than those with a lower priority.

Prioritizing log messages can provide valuable information about particular events within a system (e.g., environment 100, etc.). The prioritized log messages can also be isolated and utilized to predict future events by comparing the isolated log messages that correspond to a particular event with currently incoming log messages where the corresponding event may not be known.

At 452, the method 450 can include generating a cluster of a plurality of log messages relating to an event. As described herein, generating the cluster of a plurality of log messages relating to an event can include determining a pattern of the plurality of log messages and placing log messages with common patterns in particular clusters.

Generating the cluster can include defining a number of template features for the plurality of log messages, wherein the number of template features are consistent features for the plurality of log messages. As described herein, the template features can include criteria that are consistent between log messages within a particular cluster. For example, the template features can include titles and/or general descriptions of the information contained within the log messages. By keeping the template features within the cluster consistent, it is likely that related information will be consistent between the log messages within each cluster. For example, the template for a cluster can include a “value”. In this example, each of the log messages within the cluster can include the “value”. The “value” can represent a numerical value of performance (e.g., memory performance, processing performance, etc.) The numerical value of performance can be similar for similar events, so it can be beneficial to cluster log messages that include a similar numerical value of performance.

Generating the cluster can also include utilizing variable features within the plurality of log messages to generate the cluster, wherein the variable features are inconsistent. As described herein, the variable features can describe the template features. For example, the variable features can include a code name and/or a numerical value to describe the template features. The variable features can be utilized by comparing the variable features of incoming log messages to variable features of log messages within a plurality of clusters to determine a cluster location of the incoming log messages.

At 454, the method 450 can include receiving feedback, from a number of users, relating to an event relevance of the cluster. The feedback from the number of users can include a selection of a “like” if a log message within the cluster is determined to be a likely cause of a particular event. For example, if a user experiences an event, such as an error, the user can select “like” corresponding to a particular log message that the user believes is a cause and/or root cause of the error.

In contrast, the feedback from the number of users can include a selection of a “dislike” if the log message within the cluster is determined to be an unlikely cause of a particular event. For example, if a user experiences an event, such as a system failure, the user can select “dislike” corresponding to a particular log message that the user believes is not a cause and/or root cause of the system failure.

As described herein, the feedback can be given a particular numerical value depending upon an experience level (e.g., expertise level, etc.). For example, a greater value can be given for a selection of a “like” and/or “dislike” when the user has a relatively high experience level. The experience level of the user can be specific to the type of event that has occurred and/or can be a general experience level such as a position within an information technology (IT) department. For example, a higher value can be given to feedback provided by the system administrator compared to the value given to a particular user with less experience.

At 456, the method 450 can include isolating a number of log messages based on the feedback. Isolating the number of log messages can include determining a score for each of the number of log messages and a score for each of a number of clusters. The score for each of the number of log messages can be based in part on a correlation with a particular event. For example, a score can be given for log messages being received within a predetermined time period before and/or after the particular event occurred. The feedback numerical value feedback score) can be used in addition to the score based on the correlation with the particular event. For example, a first score can be calculated based in part on a correlation and a feedback score can be added to the first score to provide additional data when calculating the score for each of the number of log messages.

The score for each of the number of clusters can take into account the individual scores of each of the number of log messages within the particular cluster. For example, the score for each of the number of log messages can be added together in order to calculate the score for the cluster that includes the number of log messages. The score for the cluster can help determine which cluster likely includes a number of log messages that can be isolated. For example, a cluster with the highest score compared to other clusters can be determined and a number of the log messages within the cluster with the highest score can be selected and sent to a user. The user can provide feedback on these selected number of log messages. This can lower the number of log messages for which a user would have to provide feedback and/or eliminate the user having to search through a relatively large quantity of log messages to determine relevant log messages to a particular event.

In response to calculating a score for each of the number of log messages, a portion of the number of log messages can be selected to be isolated. The portion of the number of log messages that are isolated can be the number of log messages with a higher score (e.g., highest score) as compared to other log messages that potentially relate to the cause of an event.

At 458, the method 450 can include predicting a number of future events utilizing the isolated number of log messages. Predicting the number of future events can include comparing the number of isolated log messages to a number of currently received log messages (e.g., new incoming log messages). If the isolated log messages are similar enough to the currently received log messages it can be determined that an event is going to occur. It can be determined that the event that is going to occur will be a similar and/or the same event that corresponds to the isolated log messages. For example, if an isolated log message corresponds to a system failure and a currently received log message includes a similar and/or the same pattern, it can be determined that a system failure is about to occur.

As used herein, “a” or “a number of” something can refer to one or more such things. For example, “a number of log messages” can refer to one or more log messages. As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for prioritizing log messages, comprising:
generating a cluster of a plurality of log messages relating to an event;
receiving feedback, from a number of users via a communication link, relating to an event relevance of the cluster;
isolating a number of log messages based on the feedback; and
predicting a number of future events utilizing the isolated number of log messages.

2. The method of claim 1, wherein generating the cluster includes defining a number of template features for the plurality of log messages, wherein the number of template features are consistent features for the plurality of log messages.

3. The method of claim 2, wherein generating the cluster includes utilizing variable features within the plurality of log messages to generate the cluster, wherein the variable features are inconsistent for the plurality of log messages.

4. The method of claim 2, wherein generating the cluster includes determining a pattern of the number of log message template features.

5. The method of claim 2, wherein receiving feedback includes receiving information relating to whether the user experienced the event.

6. The method of claim 1, wherein utilizing the isolated log messages includes comparing the isolated log messages to currently received log messages.

7. A non-transitory machine-readable medium storing a set of instructions executable by a processor to cause a computer to:
receive a plurality of log messages;
generate a cluster of the plurality of log messages relating to an event;
provide a user interface to receive feedback, from a number of users, relating to an event relevance of the cluster;
calculate a score for each of the plurality of log messages within the cluster based on the feedback;
isolate a number of log messages based on the score; and
predict a number of future events utilizing the isolated number of log messages.

8. The medium of claim 7, wherein the isolated number of log messages correspond to a particular application.

9. The medium of claim 7, wherein the instructions executable to calculate the score execute to determine an expertise of each of the number of users.

10. The medium of claim 7, including instructions executable to display the isolated number of log messages on the user interface.

11. The medium of claim 10, wherein the instructions executable to calculate the score execute the score based on a time the number of log messages were received.

12. A system for prioritizing log messages, comprising a processing resource in communication with a non-transitory machine readable medium having instructions executed by the processing resource to implement a cluster engine, a feedback engine, an isolation engine and a prediction engine, wherein:
the cluster engine accesses a plurality of log messages;
the cluster engine generates a plurality of clusters comprising the plurality of log messages relating to an event, wherein the plurality of clusters are based on a pattern of log message features;
the feedback engine receives feedback from a number of users, via a user interface, relating to an event relevance of the cluster;
the feedback engine calculates a score for each of the plurality of log messages within the cluster based on the feedback;
the isolation engine isolates a number of log messages based on the score; and
the prediction engine predicts a number of future events utilizing the isolated number of log messages.

13. The system of claim 12, including instructions to implement the feedback engine to increase the score in response to receiving the feedback from a particular user.

14. The system of claim 13, including instructions to implement the feedback engine to determine a level of expertise of the particular user and increase the score based on the determined level of expertise.

15. The system of claim 12, wherein the feedback engine predicts a number of log messages include instructions to predict a number of future events based on a comparison of the score to a predetermined threshold score.
